(19) United States
(12) Patent Application Publication
(10) Pub. No.: US 2025/0186305 A1
(43) Pub. Date: Jun. 12, 2025

(54) PORTABLE ACTIVE MASSAGE DEVICE

(71) Applicant: Billie Rosalie Maldonado, Seattle, WA (US)

(72) Inventor: Billie Rosalie Maldonado, Seattle, WA (US)

(21) Appl. No.: 18/974,170

(22) Filed: Dec. 9, 2024

Related U.S. Application Data
(60) Provisional application No. 63/608,245, filed on Dec. 9, 2023.
(60) Provisional application No. 63/646,880, filed on May 13, 2024.

(51) Int. Cl. A61H 39/04

(52) U.S. Cl. CPC A61H 39/04; A61H 2201/0103; A61H 2201/165; A61H 2201/1695

(57) ABSTRACT

The present disclosure relates to a device and a method associated with the device. The device is a portable attachment tool, which can improve mobility, relieve tightness, and increase performance. The device includes an attachment strap, a rigid or semi-rigid protruding feature, a base containing the protruding feature which the attachment strap is connect to, and a locking mechanism on the base that fixes the strap at a certain diameter. The device when applied aids in myofascial release, compression, stability, growth hormone stimulation, lymph and circulation stimulation. With respect to the associated method, the method includes: The user wraps the strap around the affected limb locating the protrusion on the trigger point in the affected region. The strap is pulled snug, and the locking mechanism is engaged. The user then moves the affected limb through easy ranges of motion. The strap may then be removed.

### CROSS REFERENCE TO RELATED APPLICATIONS

This application claims the benefit of U.S. Provisional Patent Application No. 63/608,245 filed on Dec. 9, 2023 and U.S. Provisional Patent Application No. 63/646,880 filed on May 13, 2024, the entire contents each of which are incorporated herein by reference in their entirety.

### TECHNICAL FIELD

Exemplary embodiments of the present disclosure pertain to a portable myofascial release trigger point compression and blood flow restriction device.

### BACKGROUND

Currently, there are a number of solutions for myofascial release and massage therapies. Some of these solutions attempt to target and apply pressure to trigger points, but these solutions fail to meet the needs of the industry because they are not portable. A common solution is the use of a cylinder or roller-shaped device, commonly referred to as a “foam roller”. However, this solution takes up a larger amount of space and requires the user to bear their entire body weight to apply pressure to trigger points, often on the floor. This fails to meet the industry needs as it is not as accessible and requires a certain amount of strength and mobility for the user to be able to effectively use. Another common solution is a flexible elastic strap that is wrapped around the user's limb during exercise and/or therapy, often referred to as “muscle floss”. This fails to meet the industry needs, as it does not provide targeted compression, and requires continued tension while wrapping the strap requiring a great deal of strength and skill to wrap the elastic consistently around the limb. Other solutions attempt to affix a strap to a massager for ease of grip and positioning, but these solutions are similarly unable to meet the needs of the industry because they do not apply isolated compression to the associated limb with the option for blood flow restriction and also require consistent pressure and strength while working the affected area. Still, other solutions seek to apply simultaneous compression targeted trigger point movement therapies, but these solutions also fail to meet industry needs because they are not locking and require some skill and strength to apply consistent wrapping pressure to apply the device.

### BRIEF DESCRIPTION

Disclosed is a device that allows the user to utilize myofascial release techniques on oneself during exercise and/or muscle recovery and rehabilitation, which is easily accessible, portable, and does not require the user to overexert oneself by getting down on the ground to apply one's full body pressure onto a trigger-point device that requires the ability to hold one's body in sometimes very difficult to achieve position or apply excessive bodyweight on sensitive muscle areas. Furthermore, it would also be desirable to have a device that is adjustable, and locks into place, allowing for the desired compression to be applied without continued physical effort by the user or may be adjusted to adapt the amount of compression applied without having to use or exert an extreme amount of force from the upper body to do so. Still, further, it would be desirable to have a device that while accomplishing the above, also applies blood-flow restriction for improved mobility, recovery, and lymphatic system flow and also compression and/or stability. Therefore, there currently exists a need in the industry for a device that applies adjustable compression, myofascial release, and blood-flow restriction during exercise and/or rehabilitation, which is portable, easy to use, and widely accessible to a population of diverse strength levels. Similarly, it would be desirable to have an associated method that allows the user to reduce muscle pain and improve mobility without the need of a professional, large and/or expensive equipment, or a large amount of space. Therefore, there currently exists a need in the industry for a process that applies myofascial release and blood-flow restriction techniques to oneself, is simple to follow, and is more accessible by allowing adjustable compression to be applied to the body without continued physical effort.

Disclosed is a portable attachment tool, which is made up of the following components: an attachment portion with locking mechanism, and a rigid or semi-rigid protrusion, that is typically but not limited to a hemispherical shape, configured as follows: the protrusion is attached perpendicular to the strap face, in an arrangement that allows the protrusion to be located on the trigger point and/or tight muscle of the affected region when the strap is tightened. The strap is looped around itself, with one end inserted into the locking mechanism, forming the loop. The locking mechanism allows for the tension (diameter) of the strap to be adjusted and then set. The associated method is made up of the following steps. The user wraps the strap around the affected limb, with the protrusion located on the trigger point. The strap is then pulled snug, applying compression to the region and also reducing blood-flow to the muscle, while the protrusion acutely applies compression to the trigger point. The locking mechanism is engaged, holding the strap in the tensioned position. The user then may move the affected area through some easy ranges of motion. The strap is then removed, allowing the blood-flow to rush to the affected area.

The device may also have one or more of the following: configurations for a single or multiple protrusions on a single strap, protrusions that are removable from the strap, alternative methods for tensioning and/or locking the strap such as a ratchet system, or knob/lacing system, or the option to add vibrating and/or heating or cooling elements. Similarly, the associated method may also include one or more of the following steps: the user may hold the protrusion directly onto the trigger point and directly apply pressure. The user may also wear the device for a short period of time while they go about daily activities such as walking, instead of or in addition to targeted exercises. Alternatively, the user may mount the strap against a support such as a wall or pole and apply pressure by leaning on the protrusion.

The disclosed device is unique when compared with other known devices and solutions because it: (1) has the ability to easily adjust strap tension by pulling on a single end of the strap (2) is able to lock at the desired amount of compression on the user's limb; (3) is easily portable, and requires little extra space and no extra equipment to use. Similarly, the associated method is unique in that it (1) requires little extra strength or skill to adjust and lock the strap tension and does not require continued effort after the device is in place (2) allows the user multiple options to apply pressure to trigger points including but not limited to applying directly, or through moving through simple range of motion exercises; and (3) while also implementing blood flow restriction during exercise and/or rehabilitation. Similarly, the disclosed method is unique when compared with other known processes and solutions in that it: (1) allows for tensioning of the strap in a single process, rather than requiring continual wrapping; (2) does not require the user to hold up or utilize their own bodyweight to apply the pressure; (3) allows the user to perform self-myofascial release with the option of blood flow restriction in any environment and/or location.

The disclosed device is unique in that it is structurally different from other known devices or solutions. More specifically, the device is unique due to the presence of (1) a strap that forms a single loop for simple tensioning method; (2) has a locking mechanism that allows a desired compression to be achieved without the need for continued physical effort; (3) has the option to further reduce need for extra strength required during application by adding an inflatable bladder which will further increase compression after locking feature has been engaged; (4) and is portable and lightweight such that it can be applied to the body without adding significant weight, and allows the user to perform exercises uninhibited at any location.

Furthermore, the process associated with the aforementioned device is likewise unique. More specifically, the disclosed process owes its uniqueness to the fact that it (1) is simple and quick to apply and tension the device by pulling a single strap; (2) allows for customizable compression on the affected area by engaging a simple locking mechanism; and (3) allows for the option to apply and experience the benefits of blood flow restriction during exercise and/or rehabilitation.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The Portable Myofascial Release Trigger Point Compression and Blood Flow Restriction Device may, however, be embodied in many different forms and should not be construed as being limited to the embodiments set forth herein; rather, these embodiments are provided by way of illustration only and so that this disclosure will be thorough, complete and fully convey understanding to those skilled in the art.

Disclosed is a device that allows the user to utilize myofascial release techniques to oneself during exercise and/or muscle recovery and/or rehabilitation and/or during daily activities unrelated to exercise, which is easily accessible, portable, and does not require the user to overexert oneself by getting down on the ground to apply one's full body pressure onto a trigger-point device which requires the ability to hold one's body in sometimes very difficult to achieve positions or apply excessive bodyweight on sensitive muscle area. Furthermore, it would also be desirable to have a device that is adjustable, and locks into place, allowing for the desired compression to be applied without continued physical effort by the user or may be adjusted to adapt the amount of compression applied without having to use or exert an extreme amount of force from the upper body to do so. Still, further, it would be desirable to have a device that while accomplishing the above, also applies blood-flow restriction for improved mobility, recovery, and lymphatic system flow and also compression and/or stability. Therefore, there currently exists a need in the industry for a device that applies adjustable compression, myofascial release, and blood-flow restriction during exercise and/or rehabilitation, which is portable, easy to use, and widely accessible to a population of diverse strength levels. Similarly, it would be desirable to have an associated method that allows the user to reduce muscle pain and improve mobility without the need of a professional, large and/or expensive equipment, or a large amount of space. Therefore, there currently exists a need in the industry for a process that applies myofascial release and blood-flow restriction techniques to oneself, is simple to follow, and is more accessible by allowing adjustable compression to be applied to the body without continued physical effort.

Disclosed is a portable attachment tool, which is made up of the following components: an attachment portion with locking mechanism, and a rigid or semi-rigid protruding feature, that is typically but not limited to a hemispherical, spherical, bi-conical, or cylindrical shape, configured as follows: the protrusion is attached such that it breaks the plane of the strap face, in an arrangement that allows the protrusion to be located on the trigger point of the affected region when the strap is tightened. The strap is attached to one end of the base containing the protrusion and looped around to the other side of the base containing the protrusion, this end is inserted into the locking mechanism, forming the loop. The locking mechanism allows for the tension (diameter) of the strap to be adjusted and then set. The associated method is made up of the following steps. The user wraps the strap around the affected limb, with the protrusion located on the trigger point. The strap is then pulled snug, applying compression to the region and also reducing blood-flow to the muscle, while the protrusion acutely applies compression to the trigger point. The locking mechanism is engaged, holding the strap in the tensioned position. The user then may move the affected area through some easy ranges of motion. The strap is then removed, allowing the blood-flow to rush to the affected area.

The device may also have one or more of the following: configurations for a single or multiple protrusions on a single strap, configurations to allow a protrusion to rotate along an axis in the base containing the protrusion, protrusions to allow different shapes and or densities on the protrusion in order to change the pressure, hardness, or surface area on the trigger point, protrusions that have scraping mechanisms such that a flat portion may be scraped along the trigger point as the protrusion rotates about its axis in the base, protrusions that are removable from the base, alternative methods tensioning the strap such as an inflatable bladder, ratchet system, or knob/lacing system to adjust the tension, and the option to add vibrating and/or heating or cooling elements. Additionally there may be features in the locking system that contain protrusions such that when the lock is in the engaged position, they interface with mating cavities in the base making it difficult for the strap to be removed from the locking mechanism. Additionally there may be a portion of the base, hereon referred to as a bar that is positioned such that the strap may be wrapped around such that the angle of pull is optimized for user's ease of use. This bar may be elevated from the base such that the strap would not have to incur a line of pull with 180 degree change of direction and the elevation of it from the base would result a smaller angle in change of direction resulting in greater ease of use due to decreased resistance while pulling. Similarly, the associated method may also include one or more of the following steps: the user may hold the protrusion directly onto the trigger point and directly apply pressure. The user may also wear the device for a short period of time while they go about daily activities such as walking, instead of or in addition to targeted exercises. Alternatively, the user may mount the strap against a support such as a wall or pole and apply pressure by leaning on the protrusion.

The disclosed device is unique when compared with other known devices and solutions because it: (1) has the ability to easily adjust strap tension by pulling on a single end of the strap, the design of the base locates the geometry in which the strap interfaces with a position such that the pulling/tightening angle is optimized and avoids friction from the user's affected body part; (2) is able to lock at the desired amount of compression on the trigger points, the design of the base and lock is optimized using bi-stable geometries allowing for the closed position to be secured while holding the attachment strap in a locked position; (3) has the option to configure a rotation protrusion which eliminates unwanted twisting during application and also allows for voluntary rotation by the user to gain the benefit of rolling over affected area or apply a scraping sensation; (4) has the option to change out protrusions for a variety of geometries and positions to the benefit of different applications; (5) is easily portable, and requires little extra space and no extra equipment to use. Similarly, the associated method is unique in that it (1) requires little extra strength or skill to adjust and lock the strap tension and does not require continued effort after the device is in place (2) allows the user multiple options to apply pressure to trigger points including but not limited to applying directly, through moving through simple range of motion exercises, usage during daily non-exercise related tasks, by manually rotating the protrusion device on the affected area, and/or by attaching device to fixed object and pressing affected body part on it; and (3) while also implementing blood flow restriction during exercise and/or rehabilitation. Similarly, the disclosed method is unique when compared with other known processes and solutions in that it: (1) allows for tensioning of the strap in a single process, rather than requiring continually wrapping; (2) does not require the user to hold up or utilize their own bodyweight to apply the pressure; (3) allows the user to perform self-myofascial release with the option of blood flow restriction in any space and/or location.

The disclosed device is unique in that it is structurally different from other known devices or solutions. More specifically, the device is unique due to the presence of (1) an attachment strap that forms a single loop and easy line of pull for simple tensioning method; (2) has a locking mechanism that allows a desired compression to be achieved without the need for continued physical effort that locks into place with bi-stable mechanism; (3) has the option to further reduce need for extra strength during application by adding an inflatable bladder which will further increase compression after locking feature has been engaged; (4) has the option to have the protrusion rotate about an axis; (5) and is portable and lightweight such that it can be applied to the body and worn without adding significant weight, and allows the user to perform exercises or movement patterns uninhibited at any location.

Furthermore, the process associated with the aforementioned device is likewise unique. More specifically, the disclosed process owes its uniqueness to the fact that it (1) is simple and quick to apply and tension the device by pulling a single strap at an easy line of pull; (2) allows for customizable compression on the affected area by engaging a simple locking mechanism; and (3) allows for the option to rotate the protrusion to roll over affected area or apply a scraping movement over the affected area; (4) allows for the option to apply and experience the benefits of blood flow restriction during exercise and/or rehabilitation.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The portable myofascial release trigger point compression and blood flow restriction device may, however, be embodied in many different forms and should not be construed as being limited to the embodiments set forth herein; rather, these embodiments are provided by way of illustration only and so that this disclosure will be thorough, complete and fully convey understanding to those skilled in the art.

Also disclosed is a device that allows a user to utilize myofascial release techniques on oneself during exercise and/or muscle recovery and rehabilitation, the device including: a base; an attachment portion having one end secured to and extending from the base; a locking mechanism, the locking mechanism being configured to secure a portion of the attachment portion to the base; and a protrusion having at least one surface extending outwardly from the base.

In addition to one or more of the features described above, or as an alternative to any of the foregoing embodiments, the protrusion is rigid or semi-rigid.

In addition to one or more of the features described above, or as an alternative to any of the foregoing embodiments, the protrusion and/or the attachment portion is inflatable.

In addition to one or more of the features described above, or as an alternative to any of the foregoing embodiments, the protrusion has a hemispherical shape.

In addition to one or more of the features described above, or as an alternative to any of the foregoing embodiments, the protrusion extends from opposite sides of the base.

In addition to one or more of the features described above, or as an alternative to any of the foregoing embodiments, the protrusion is rotatably secured to the base.

In addition to one or more of the features described above, or as an alternative to any of the foregoing embodiments, the protrusion has a second protrusion.

In addition to one or more of the features described above, or as an alternative to any of the foregoing embodiments, the protrusion is rotatably secured to the base.

In addition to one or more of the features described above, or as an alternative to any of the foregoing embodiments, the attachment portion is an elastic strap.

In addition to one or more of the features described above, or as an alternative to any of the foregoing embodiments, the protrusion is rotatably secured to the base and is perpendicularly arranged to a face of the attachment portion.

In addition to one or more of the features described above, or as an alternative to any of the foregoing embodiments, the attachment portion is a first attachment portion and the device includes a second attachment portion.

In addition to one or more of the features described above, or as an alternative to any of the foregoing embodiments, the first attachment portion is an elastic strap and the second attachment portion is an elastic strap.

In addition to one or more of the features described above, or as an alternative to any of the foregoing embodiments, the protrusion is rigid or semi-rigid.

In addition to one or more of the features described above, or as an alternative to any of the foregoing embodiments, the protrusion is inflatable.

In addition to one or more of the features described above, or as an alternative to any of the foregoing embodiments, the protrusion extends from opposite sides of the base and the protrusion is rotatably secured to the base.

In addition to one or more of the features described above, or as an alternative to any of the foregoing embodiments, the protrusion has a second protrusion.

In addition to one or more of the features described above, or as an alternative to any of the foregoing embodiments, the protrusion has a shape of a turtle and the second protrusion corresponds to a head of the turtle.

In addition to one or more of the features described above, or as an alternative to any of the foregoing embodiments, the locking mechanism is pivotally secured to the base.

Also disclosed is a device that allows a user to utilize myofascial release techniques on oneself during exercise and/or muscle recovery and rehabilitation, the device including: a locking mechanism with an opening; an attachment portion having one end secured to and extending from the locking mechanism, the locking mechanism being configured to secure a portion of the attachment portion to the locking mechanism; and a protrusion rotatably received within the opening of the locking mechanism and having at least one surface extending outwardly from the locking mechanism.

Also disclosed is a method that allows a user to utilize myofascial release techniques on oneself during exercise and/or muscle recovery and rehabilitation, the method including: tightening a device about a portion of the user, the device comprising: a base; an attachment portion having one end secured to and extending from the base; a locking mechanism, the locking mechanism being configured to secure a portion of the attachment portion to the base; and a protrusion having at least one surface extending outwardly from the base; locking the device in a tightened state about the portion of the user, such that the protrusion contacts the user, the locking step includes a tightening of the attachment portion about the user; performing an exercise and/or muscle recovery activity with the device in the tightened state; and loosening the device from the tightened state by loosening the attachment portion.

### BRIEF DESCRIPTION OF THE DRAWINGS

The following descriptions should not be considered limiting in any way. With reference to the accompanying drawings, like elements are numbered alike:

FIG. 1 shows a side cross-sectional view of the device with elastic attachment and clamp locking mechanism which is one particular embodiment of the present disclosure;

FIG. 2 shows a side cross-sectional view of the device with non-elastic attachment and hook and loop locking mechanism with inflatable bladder, which is one particular embodiment of the present disclosure;

FIG. 3 shows an isometric view of one particular version of the present disclosure looped and locked in place;

FIG. 4 shows an isometric view of one particular version of the embodiment of the present disclosure located on a trigger point with attachment looped and locked in place;

FIG. 5 shows an assembled view of an embodiment of the present disclosure;

FIGS. 6A-6D are assembled views of an embodiment of the present disclosure with the attachment portion removed;

FIGS. 7A-7G shows a piece-by-piece view of one version of an embodiment of the present disclosure with the attachment portion removed;

FIGS. 8A-8G show several views of one version of the base portion of the present disclosure;

FIGS. 9A-9E shows several views of one version of the locking portion of the present disclosure;

FIGS. 10A-10D shows a round protrusion, which is a part of one particular embodiment of the trigger point interfacing mechanism of the present disclosure;

FIGS. 11A-11F shows a turtle-shaped protrusion, which is a part of one particular embodiment of the trigger point interfacing mechanism of the present disclosure;

FIGS. 12A-12C shows a protrusion with scraping flats, which is a part of one particular embodiment of the trigger point interfacing mechanism of the present disclosure;

FIGS. 13A-13B shows an elastic attachment strap, which is a part of one particular embodiment of the attaching mechanism of the present disclosure;

FIGS. 14A-14B shows a non-elastic attachment strap with inflatable bladders, which is a part of one particular embodiment of the attaching mechanism of the present disclosure;

FIGS. 15A-15F shows a front insert for the base and protrusion axle interface, which is a part of one particular embodiment of the present disclosure;

FIGS. 16A-16F shows a back insert for the base and protrusion axle interface, which is a part of one particular embodiment of the present disclosure;

FIGS. 17A-17C shows cross-sections of the assembly excluding the attachment portion, which is one particular embodiment of the present disclosure;

FIG. 18 shows an example of an improved angle of pull for ease of use in accordance with an embodiment of the present disclosure;

FIG. 19 illustrates an embodiment of the present disclosure wherein a second strap is added; and

FIG. 20 illustrates an embodiment of the present disclosure wherein a second strap is added.

### DETAILED DESCRIPTION

A detailed description of one or more embodiments of the disclosed apparatus and method are presented herein by way of exemplification and not limitation with reference to the Figures.

The present disclosure is directed to a portable myofascial release trigger point compression and blood flow restriction device.

In one embodiment, the device is made up of the following components: an attachment portion such as a strap that may be flexible or form-changing in nature such that attachment would result in compression of the affected limb (an example of the strap's flexibility may be due to elasticity of the material while the form changing nature may be a result of a non-elastic cuff that may be inflated to change the inner diameter of the cuff thus compressing the limb within), with locking mechanism such that the attachment portion may be easily applied or removed from the affected limb, and a rigid or semi-rigid protrusion, that is typically but not limited to a hemispherical shape. These components are connected as follows: the protrusion is attached perpendicular to the wide flat section of the attachment face, in an arrangement that allows the protrusion to be located on a targeted area such as a trigger point in the affected region of the user. The locking mechanism on the attachment portion is such that one end may be inserted through the mechanism, forming a loop, then pulled through the mechanism to adjust the diameter of the loop until the desired tension has been achieved before locking that diameter into place. It should further be noted that some options include but are not limited to an elastic strap that may be used with a locking feature or a non-elastic cuff that may be further modified using a pump and bladder to further decrease the diameter of the attachment feature. The protrusion may be permanently affixed to the strap, or it may be removable and/or exchangeable. Additionally, there may be more than one protrusion affixed to the strap.

In one embodiment, a method associated with the disclosed device consists of the following steps: The user wraps the attachment portion around the affected limb, locating the protrusion on the trigger point of the affected region. The strap is then pulled snug, applying compression to the region which may also provide some stability to the underlying muscular structure. The locking mechanism is engaged, holding the strap in the tensioned position (additional compression may be applied in the option of a device which contains an expanding bladder in the attachment portion, or manually by the user if so chosen). While the attachment is in place, the trigger point is also compressed more acutely via the protrusion which provides myofascial pressure and subsequently triggers release of tension in the trigger point. The user then may move the affected area through some easy ranges of motion to aid in myofascial release of the trigger point similar to an active release technique. The attachment while in place will also create blood flow restriction such that when the strap is removed it will allow blood flow to rush to the affected area (which has been shown to increase lymph circulation, growth hormone, and insulin-like growth factor as reported in pubmed article shown at the following location (https://pubmed.ncbi.nlm.nih.gov/34486432/). It should further be noted that: the desired tension may be adjusted such that it aids in applying pressure to the trigger point via the protrusion, with or without restricting blood flow, reducing the required amount of pressure that is manually applied by the user. Ultimately, at the conclusion of the associated method, the user will have experienced the benefits of compression, acupressure and blood-flow restriction including but not limited to releasing tension of the trigger point, reducing muscle tension in the affected area, and improved lymphatic system flow and muscle recovery.

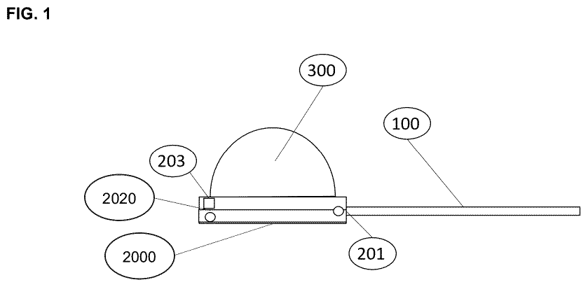

FIG. 1 shows a side cross-sectional view of the device with an elastic attachment (100), a locking mechanism (2000) with clamping method, and a protrusion (300), which is one particular version of the mechanism. To apply the device, the protrusion (300) is located on a trigger point, and the attachment (100) is wrapped around the limb. One end of the attachment is inserted into an opening (2020) on the locking mechanism (2000), and then pulled to apply the desired compression. A clamp (203) on the locking mechanism is then pressed down such that the engagement portion is locked and holds the attachment in place.

FIG. 2 shows a side cross-sectional view of the device with a non-elastic attachment (100) and the locking mechanism (2000) with a hook and loop structure and inflatable bladder, which is one particular version of the mechanism. To apply this version of the device, the protrusion (300) is located on the trigger point, and the attachment (100) is wrapped around the limb. One end of the attachment is inserted through a redirecting piece (201) on the device, for example, a buckle frame, and then pulled back onto itself such that it is overlapping on itself, and tightened to stay in place. The overlapping portion of the attachment is pressed flat, such that the hook surface (202) on the attachment engages with the loop surface (204), thus holding the attachment in the locked state. To tighten the device, the bladder on the attachment (103) is then inflated by means of a pumping mechanism which may be mechanical or electrical in nature, to achieve the desired compression.

FIG. 3 shows an isometric view of one particular version of the device with attachment (100) looped and locked in place with the clamp locking mechanism (2000), and the protrusion (300) utilizing an optional branded themed appearance in this case with the likeness of a turtle.

FIG. 4 shows an isometric view of one particular version of the device with attachment (100) looped and locked into place. The device is applied to the user's limb, with the protrusion (300) located on trigger point (301).

Various embodiments of the present disclosure are directed to a portable myofascial release trigger point compression and blood flow restriction device.

In one embodiment, the device is made up of the following components: an attachment portion such as a strap that may be flexible or form changing in nature such that attachment would result in compression of the affected limb (an example of the straps flexibility may be due to elasticity of the material while the form changing nature may be a result of a non-elastic cuff that may be inflated to change the inner diameter of the cuff thus compressing the limb within), that is attached to a base containing a protrusion and may be looped around to interface with the other side of the base and with the locking mechanism such that the attachment portion may be easily applied or removed from the affected limb, and a rigid or semi-rigid protrusion, that is typically but not limited to a hemispherical, spherical, conical, bi-conical, or cylindrical shape. These components are connected as follows: the protrusion is attached to the base such that it breaks the surface of the flat face of the attachment strap, in an arrangement that allows the protrusion to be located on a trigger point in the affected region of the user. The locking mechanism on the base is such that the attachment strap may be connected to one end and then looped around to the other end and may be inserted through the mechanism, forming a loop, then pulled through the mechanism to adjust the diameter of the loop until the desired tension has been achieved before locking that diameter into place. It should further be noted that some options include but are not limited to a protrusion that is composed of different materials and/or densities or may have added formations on the geometry which may result in changing pressure, hardness, or surface area of the trigger point it is being applied to. Other options may also include but are not limited to having the protrusion configured such that it is able to rotate about an axis. This rotation may be configured such that it allows for easier application to body parts where otherwise a non-rotating protrusion would result in an undesirable twisting or rolling of the device. The rotation may also be configured such that it would allow for the user to take advantage of a protrusion's geometry such as a scraping portion such that the user could voluntarily rotate the protrusion to get a scraping sensation across the affected area. Still other options may include but are not limited to an elastic strap that may be used with a locking feature or a non-elastic cuff that may be further modified using a pump and bladder to further decrease the diameter of the attachment feature. The protrusion may be permanently affixed to the base and/or strap, or it may be removable. Additionally, there may be more than one protrusion affixed to the base and/or strap.

In one embodiment, a method associated with the disclosed device comprises of the following steps: The user wraps the attachment portion around the affected limb, locating the protrusion on the trigger point of the affected region. The strap is then pulled snug, applying compression to the region which may also provide some stability to the underlying muscular structure. The locking mechanism is engaged, holding the strap in the tensioned position (additional compression may be applied in the option of a device which contains an expanding bladder in the attachment portion). While the attachment is in place the trigger point is also compressed more acutely via the protrusion which provides myofascial pressure and subsequently triggers release of tension in the trigger point. The user then may move the affected area through some easy ranges of motion to aid in myofascial release of trigger point, alternatively in an optional configuration, the user may choose to rotate the protrusion to roll over the affected area or apply a scraping motion over the affected area. The attachment while in place will also create blood flow restriction such that when the strap is removed it will allow blood-flow to rush to the affected area (which has been shown to increase lymph circulation, growth hormone, & insulin like growth factor as reported in pubmed article shown here https://pubmed.ncbi.nlm.nih.gov/34486432/). It should further be noted that: the desired tension may be adjusted such that it aids in applying pressure to the trigger point via the protrusion, with or without restricting blood flow, reducing the required amount of pressure that is manually applied by the user. Ultimately, at the conclusion of the associated method, the user will have experienced the benefits of compression, acupressure and blood-flow restriction including but not limited to releasing tension of the trigger point, reducing muscle and/or myofascial tension in the affected area, and improved lymphatic system flow and muscle recovery.

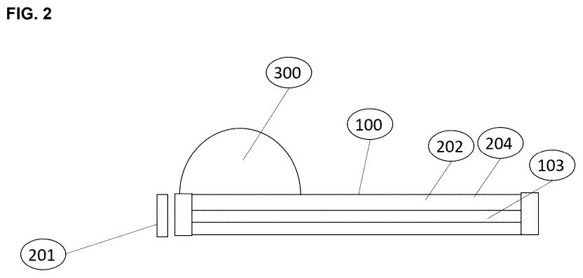

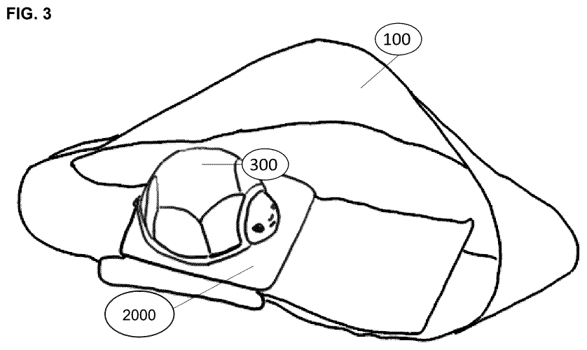

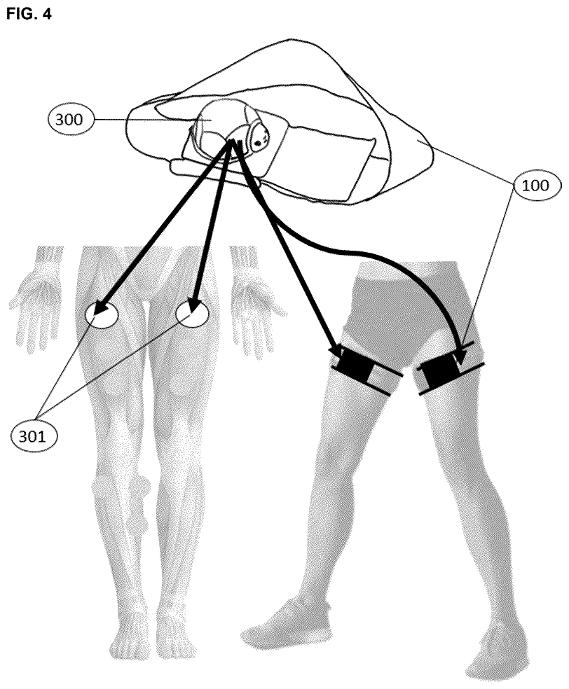

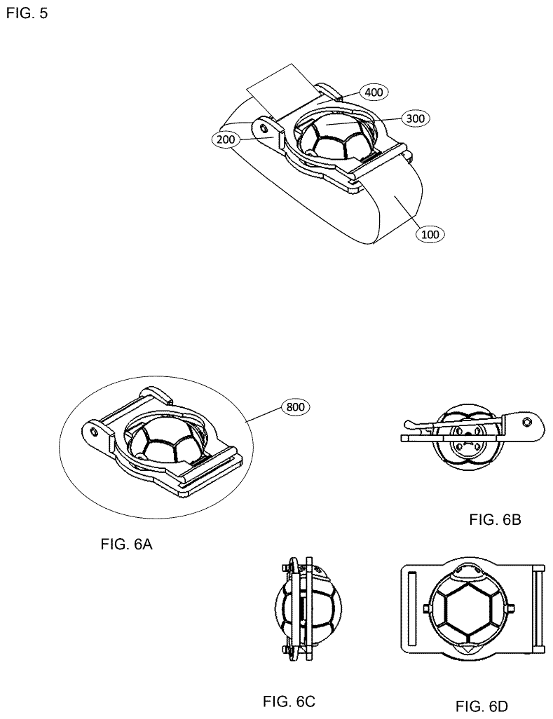

FIG. 5 shows an assembled view of one embodiment of the device, where the attachment portion (100) is attached to one side of a base (200) and looped around to be inserted into the other side of the base (200) and a locking portion (400). Located in the base is the protrusion (300) which is the part that is placed on the trigger point of the user.

FIGS. 6A-6D shows assembled views of one version of the device with the attachment portion removed (800).

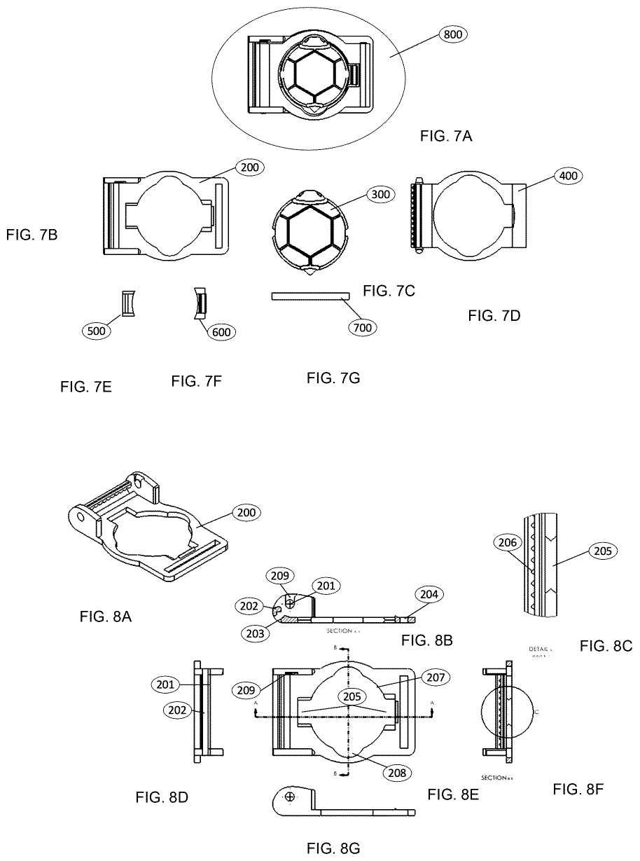

FIGS. 7A-7G shows a piece-by-piece view of one version of the device with the attachment portion removed (800), where a front insert (500) and a back insert (600) are removed from the base (200) for ease of manufacturing and mold making. Similarly, an axle/rod (700) is removed from the protrusion (300) and a locking portion (400) is removed from the base (200). In one non-limiting embodiment of the present disclosure and as illustrated, the protrusion (300) is rotatably received on the axle or rod (700) by for example passing the axle or rod (700) through an opening in the protrusion (300) so the axle or rod (700) extends from opposite sides of the protrusion (300) and one end of the axle or rod (700) is secured to the front insert (500) and an opposite end of the axle or rod (700) is secured to the back insert (600) after the axle or rod (700) is secured to the protrusion (300). The front insert (500) and the back insert (600) being secured to the base (200) after the protrusion (300) is rotatably received on the axle or rod (700) and the axle or rod (700) is secured to the front insert (500) and the back insert (600). In yet another non-limiting alternative embodiment, the axle or rod (700) is fixedly secured to the protrusion (300) and the axle or rod (700) is rotatably received within the front insert (500) and the back insert (600). In yet another alternative non-limiting embodiment, the front insert (500) and the back insert (600) may be removably secured to the base (200) (e.g. snap fit or equivalents thereof) such that the protrusion (300) may be replaced with another protrusion (300) due to wear and tear and/or protrusions (300) of other configurations and/or sizes (e.g., larger or smaller).

As illustrated the protrusion (300) when secured to the base (200) extends from opposite sides of the base (200) and is rotatably secured thereto.

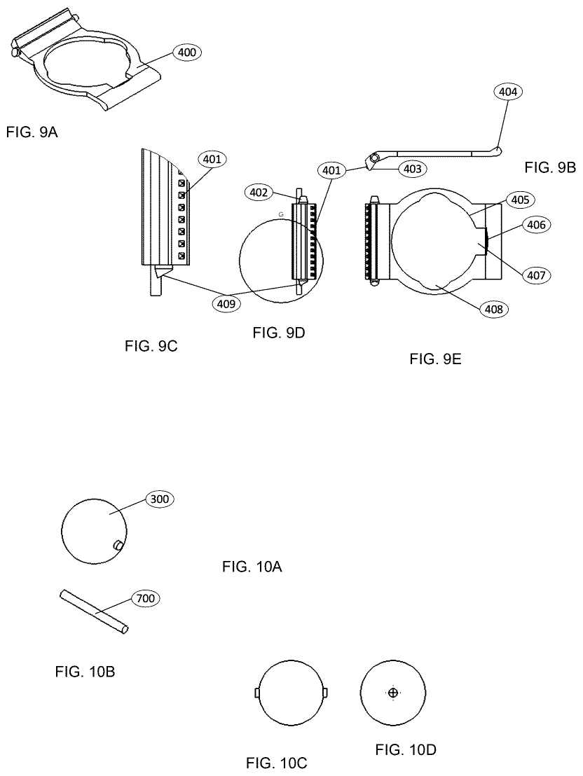

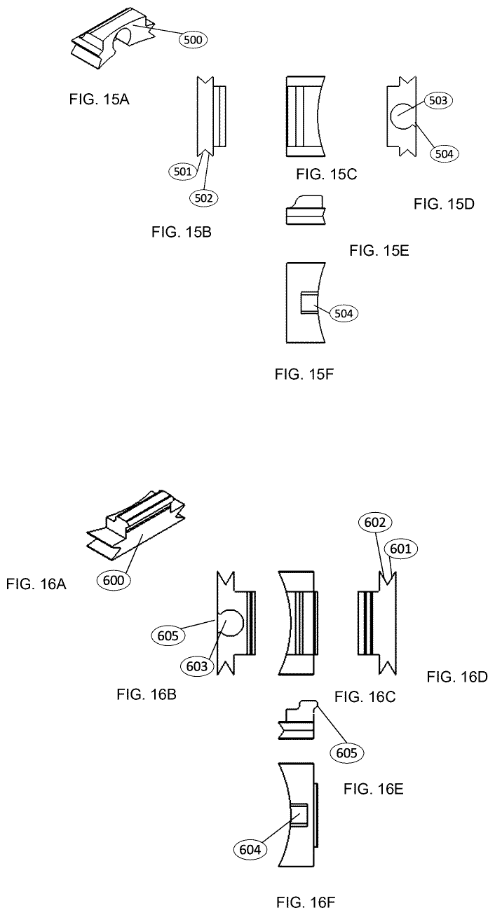

FIGS. 8A-8G shows many views of one version of the base (200) portion of the device. As shown, there are two holes (201) that interface with the locking mechanism (see FIG. 9D (402)), and one of the holes has a guided chamfer (209) for ease of assembly. There is an attachment bar (202) that is elevated from the bottom surface of the base which affects angle of pull during tightening applications. There is a bi-stable geometry (203) that aides in keeping the locking mechanism in place while engaged. There is an attachment hole (204) in the back of the base to secure the attachment feature. There are two slots (205) that locate the front and back inserts (see FIGS. 15A-16F). There are locking cavities (206) that engage with the attachment strap and locking portion. There are cavities in the base that allow for the trigger point protrusion to sit in the base (207) and allow for the protrusion to have other shapes that are not spherical in nature (208).

FIGS. 9A-9E shows many views of one version of the locking portion of the device. There are locking protrusions (401) that interface with the attachment strap and locking cavities (206) in the base (200). There are axle portions (402) that interface with holes (201) in the base and one of them contains a chamfer (409) that interfaces with the base chamfer (209) for ease of assembly. There is a bi-stable nub (403) that interfaces with base geometry (203) that aids in keeping the locking mechanism in place while engaged. There is curved geometry (404) that allows user to lift the lock out of locked position. There are cavities in the locking portion of the device that allow for the trigger point protrusion to sit in the base and not be interfered with when locking mechanism moves from locked and unlocked positions (405) and also allow for the protrusion to have other shapes that are not spherical in nature (408). There is a cavity that allows for the back insert to not interfere with locking mechanism when it moves from locked and unlocked positions (407) with the exception of the portion that is a bi-stable geometry (406) that aids in keeping the locking mechanism in place while engaged.

FIGS. 10A-10D shows a round trigger point protrusion (300) that is spherical in nature and an axle/rod (700) that interfaces with the front and back inserts (see FIGS. 15A-16F), which is a part of one particular version of the trigger point interfacing mechanism.

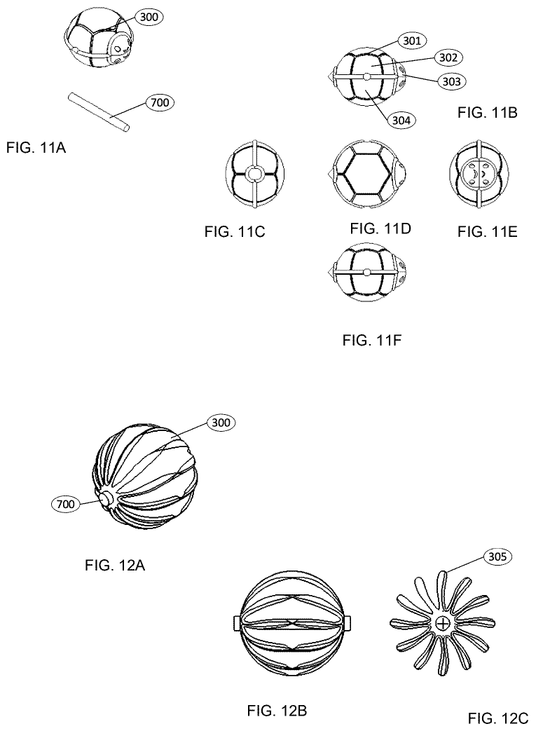

FIGS. 11A-11F shows a turtle-shaped trigger point protrusion (300), and an axle/rod (700). There is indented geometry (301) and extruding geometry (303) and may have different materials/densities/hardness in areas (302) and (304) which is a part of one particular version of the trigger point interfacing mechanism. In one embodiment, the extruding geometry (303) may be referred to as a second protrusion (303) extending from protrusion (300). In other words, protrusion (300) is a first protrusion and the second protrusion (303) extends from the first protrusion (300). In the turtle shaped embodiment of the protrusion (300), the first protrusion (300) may be referred to as the body or shell of the turtle and the second protrusion (303) may be referred to as the head of the turtle. Of course, other configurations are contemplated to be within scope of the present disclosure. For example, and in one non-limiting embodiment, the first protrusion (300) may be circular or elliptical object and the second protrusion (303) may be another smaller protrusion extending from a surface of the first protrusion (300). In one non-limiting embodiment, the second protrusion (303) has a surface area that is smaller than a surface area of the first protrusion (300).

FIGS. 12A-12C shows a trigger point protrusion with scraping flats (300) and an axle/rod (700), which is a part of one particular version of the trigger point interfacing mechanism.

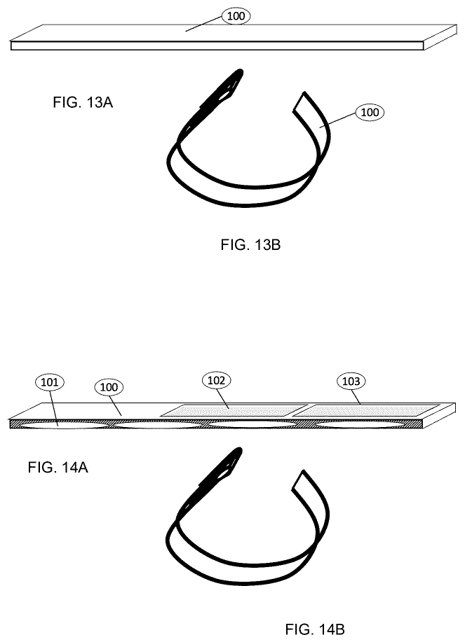

FIGS. 13A-13B shows an elastic attachment strap (100), which is a part of one particular version of the attaching mechanism.

FIGS. 14A-14B shows a non-elastic attachment strap (100) with inflatable bladders (101) and hook (102) and loop (103) attachment features, which is a part of one particular version of the attaching mechanism.

FIGS. 15A-15F shows a front insert (500) for one of the slots (205) of the base (200) and trigger point protrusion axle/rod (700) interface. There are interlocking geometries (502) and (501) that interface with the slots (205) of the base (200), an axel/rod cavity (503) that allows the trigger point protrusion axle/rod (700) to be secured and still allow rotation, and a snap fit hole (504) for ease of assembly, which is a part of one particular version of the device. In one non-limiting embodiment, the trigger point protrusion (300) is rotatable received on the axle/rod (700) that is secured to the base.

FIGS. 16A-16F shows a back insert (600) for one of the slots (205) of the base (200) and trigger point protrusion axel/rod (700) interface. There are interlocking geometries (602) and (601) that interface with the slots (205) of the base (200), an axle/rod cavity (603) that allows the trigger point protrusion axle/rod (700) to be secured and still allow rotation, a snap fit hole (604) for ease of assembly, and a bi-stable geometry (605) which aids in keeping the locking mechanism in place while engaged, which is a part of one particular version of the device.

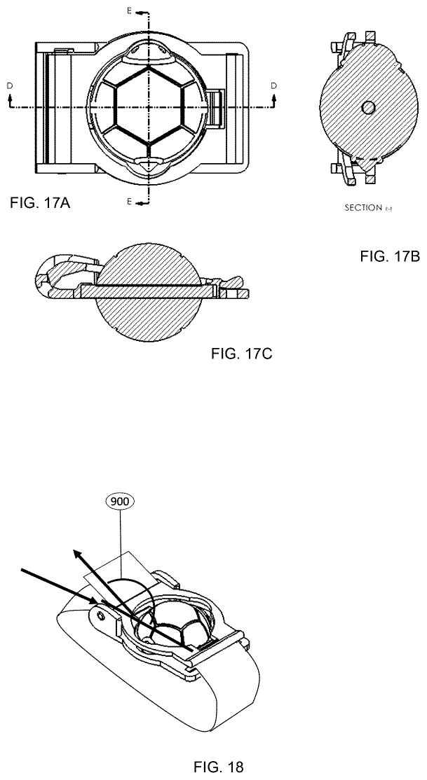

FIGS. 17A-17C shows cross-sections of the assembly excluding the attachment portion, which is one version of the device.

FIG. 18 shows an example of an improved angle of pull (900) for ease of use.

Depending on how the device is manufactured may affect the parts described above. The front and back inserts (500) and (600) are separated from the base (200) in order to make an injection molded part without any undercuts. By separating these features, the mold can be made simply with a core and cavity for each part.

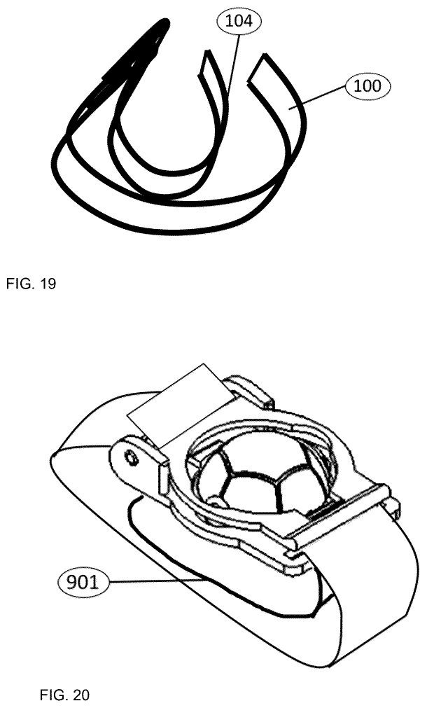

Referring now to FIGS. 19 and 20, an alternative configuration of the present disclosure is illustrated. Here the device includes a secondary strap (901). The second strap (901) allows users to attach the product to the body without having to tighten it the entire time. This makes it possible to use during a workout when you want to add and remove tension frequently in intervals without having to completely remove the device from the body. In other words, the user can place the device on an effected area with the positioning strap, tighten it with tensioning strap which applies pressure to trigger point, go through range of motion exercise, release tensioning during break, tighten again to do next set of range of motion exercise. In one non-limiting embodiment, the secondary strap (901) may be an elastic strap. It being understood that that second strap (901) may be used with any of the aforementioned embodiments.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A device that allows a user to utilize myofascial release techniques on oneself during exercise and/or muscle recovery and rehabilitation, the device comprising:
a base;
an attachment portion having one end secured to and extending from the base;
a locking mechanism, the locking mechanism being configured to secure a portion of the attachment portion to the base; and
a protrusion having at least one surface extending outwardly from the base.

2. The device as in claim 1, wherein the protrusion is rigid or semi-rigid.

3. The device as in claim 1, wherein the protrusion and/or the attachment portion is inflatable.

4. The device as in claim 1, wherein the protrusion has a hemispherical shape.

5. The device as in claim 1, wherein the protrusion extends from opposite sides of the base.

6. The device as in claim 1, wherein the protrusion is rotatably secured to the base.

7. The device as in claim 1, wherein the protrusion has a second protrusion.

8. The device as in claim 7, wherein the protrusion is rotatably secured to the base.

9. The device as in claim 1, wherein the attachment portion is an elastic strap.

10. The device as in claim 1, wherein the protrusion is rotatably secured to the base and is perpendicularly arranged to a face of the attachment portion.

11. The device as in claim 1, wherein the attachment portion is a first attachment portion and the device includes a second attachment portion.

12. The device as in claim 11, wherein the first attachment portion is an elastic strap and the second attachment portion is an elastic strap.

13. The device as in claim 12, wherein the protrusion is rigid or semi-rigid.

14. The device as in claim 12, wherein the protrusion is inflatable.

15. The device as in claim 1, wherein the protrusion extends from opposite sides of the base and the protrusion is rotatably secured to the base.

16. The device as in claim 15, wherein the protrusion has a second protrusion.

17. The device as in claim 16, wherein the protrusion has a shape of a turtle and the second protrusion corresponds to a head of the turtle.

18. The device as in claim 1, wherein the locking mechanism is pivotally secured to the base.

19. A device that allows a user to utilize myofascial release techniques on oneself during exercise and/or muscle recovery and rehabilitation, the device comprising:
a locking mechanism with an opening;
an attachment portion having one end secured to and extending from the locking mechanism, the locking mechanism being configured to secure a portion of the attachment portion to the locking mechanism; and
a protrusion rotatably received within the opening of the locking mechanism and having at least one surface extending outwardly from the locking mechanism.

20. A method that allows a user to utilize myofascial release techniques on oneself during exercise and/or muscle recovery and rehabilitation, the method comprising:
tightening a device about a portion of the user, the device comprising: a base; an attachment portion having one end secured to and extending from the base; a locking mechanism, the locking mechanism being configured to secure a portion of the attachment portion to the base; and a protrusion having at least one surface extending outwardly from the base;
locking the device in a tightened state about the portion of the user, such that the protrusion contacts the user, the locking step includes a tightening of the attachment portion about the user;
performing an exercise and/or muscle recovery activity with the device in the tightened state; and
loosening the device from the tightened state by loosening the attachment portion.
